(19) United States
(12) Patent Application Publication
(10) Pub. No.: US 2003/0075953 A1
(43) Pub. Date: Apr. 24, 2003

(54) Impact energy absorbing component

(75) Inventors: Tomoo Hirota, Ichihara-shi (JP); Yosuke Miyazaki, Ichihara-shi (JP); Masaaki Tsutsubuchi, Chiba-shi (JP)

Correspondence Address: FITCH EVEN TABIN AND FLANNERY, 120 SOUTH LA SALLE STREET, SUITE 1600, CHICAGO, IL, 60603-3406, US

(73) Assignee: Sumitomo Chemical Company, Limited

(21) Appl. No.: 10/255,081

(22) Filed: Sep. 26, 2002

(30) Foreign Application Priority Data
Sep. 26, 2001 (JP) P2001-293175

(51) Int. Cl. B60R 21/02

(52) U.S. Cl. 296/189; 280/751

(57) ABSTRACT

A resin impact energy absorbing component that is disposed between a structural member of an automobile and a resin internal material arranged on the inner side of the compartment with respect to the structural member, is constituted by arranging a high-rigidity brittle fracture portion and a low-rigidity ductile fracture portion in a parallel fashion. “High-rigidity brittle fracture portion” can be defined as a component that has a large repulsive force at unit deformation (load [N]) and that undergoes fracture at low deformation, and “low-rigidity ductile fracture portion” can be defined as a component that has a small repulsive force at unit deformation (load [N]) and that undergoes fracture at high deformation.

### BACKGROUND OF THE INVENTION

1. Field of the Invention

The present invention relates to an impact energy absorbing component in the passenger compartment of an automobile, and more specifically to an impact energy absorbing component suitable for alleviating the impact energy acting on the passengers whenever an impact load is applied to the vehicle when the automobile collides or rolls.

2. Related Background Art

Recently, in components for automobiles and other such vehicles, there has been a trend of setting higher standards concerning protective measures for passengers in accidents such as collisions and rolling. In particular, the U.S. has established the Federal Motor Vehicle Safety Standards (FMVSS 201,208, 214, etc.) and has set strict standards. Consequently, instrument panels, pillar garnishes, door trims, and other such vehicle components are required to have functions for absorbing impact energy.

The impact energy absorbing structure of an automobile is composed of structural members such as the frame, door panels, a resin internal material that constitutes the passenger compartment and is disposed on the inside of these structural members, and resin impact energy absorbing components disposed between these elements. Japanese Patent Application Laid-open Nos. H8-58507 and H10-35378 disclose a structure where walls (internal members) and rib structures (impact energy absorbing components) are formed integrally.

### SUMMARY OF THE INVENTION

However, such a structure is configured with low rigidity to prevent high impact load from being applied to the human body, and some deformation needs to occur until the load generated at impact reaches a peak value. Consequently, the thickness of the structure must be increased to allow the structure to absorb the impact energy so that the passengers do not collide with the structural member of the automobile at a high velocity when the structure deformation reaches its limit (when it bottoms out). This causes adverse affects such as reducing visibility and impairing comfort by reducing the space of the passenger compartment. Conversely, if the impact absorbing structure is configured with high rigidity, a high impact load will be applied and protection of the human body cannot be ensured.

With the foregoing in view, it is an object of the present invention to provide an impact energy absorbing component with an ability of absorbing impact energy sufficiently at small deformation so as to have sufficient functions of protecting the human body while preserving visibility and sufficient space within the passenger compartment.

The present invention, which is designed to achieve the above-mentioned objects, provides a resin impact energy absorbing component disposed between structural members of an automobile and a resin internal material arranged on the inner side of the passenger compartment with respect to the structural members, wherein this impact energy absorbing component is characterized by being constituted by arranging a high-rigidity brittle fracture portion and a low-rigidity ductile fracture portion in a parallel fashion. As used herein the term “high-rigidity brittle fracture portion” can be defined as a component that has a large repulsive energy at unit deformation (load [N] versus deformation) and that undergoes fracture at small deformation, and “low-rigidity ductile fracture portion” can be defined as a component that has a small repulsive energy at unit deformation (load [N] versus deformation) and that undergoes fracture at high deformation. Specifically, it is fair to say that a low-rigidity ductile fracture portion has a low load [N] versus deformation and has considerable limiting deformation to fracture in comparison with a high-rigidity brittle fracture portion.

This arrangement provides an impact energy absorbing component in which a high-rigidity brittle fracture portion and a low-rigidity ductile fracture portion are deformed in parallel, resulting in a deformational behavior that combines the deformational behaviors of the two components during absorption. Specifically, the high-rigidity brittle fracture portion is deformed while applying a large repulsive force to the colliding object, and the component absorbs a large amount of kinetic energy but fractures at small deformation. Conversely, the low-rigidity ductile fracture portion does not absorb a large amount of kinetic energy due to its small repulsive energy at a unit deformation, and remains unfractured until the very last moment because it undergoes fracture at high deformation. Consequently, it is possible to provide an impact energy absorbing component whose impact energy absorbing ability is sufficient with small overall deformation without an increased load at the end of deformation.

In the present invention, the high-rigidity brittle fracture portion preferably should fracture before the low-rigidity ductile fracture portion does and no longer be involved in impact energy absorption during the deformation of the impact energy absorbing component. Thus, it is possible to prevent the peak load value from increasing by designing the high-rigidity brittle fracture portion to fracture in the middle of deformation.

In the present invention, a structurally fragile section preferably should be formed in the high-rigidity brittle fracture portion. This makes it easy to set the fracture timing of the high-rigidity brittle fracture portion and to control the deformational behavior of the impact energy absorbing component and the accompanying impact energy absorbing characteristics.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic view of the impact energy absorbing component of the present invention and a colliding object;

FIG. 2 is a schematic view of the impact energy absorbing component of the present invention and a colliding object;

FIG. 3 is a schematic view depicting a high-rigidity brittle fracture portion of the impact energy absorbing component of the present invention;

FIG. 4 is an expanded view of a high-rigidity brittle fracture portion of the impact energy absorbing component of the present invention;

FIG. 5 is a schematic view depicting a low-rigidity ductile fracture portion;

FIG. 6 is a geometrical model of the impact energy absorbing component of the present invention and a colliding object used in a simulation with which collision performance was evaluated;

FIG. 7 is a graph depicting the relationship between deformation volume and repulsive force (load) observed when collision performance is evaluated for the impact energy absorbing component of the present invention;

FIG. 8 is a graph depicting the relationship between deformation volume and repulsive force (load) observed when collision performance is evaluated with the low-rigidity ductile fracture portion alone, as in comparative example 1;

FIG. 9 is a graph depicting the relationship between deformation volume and repulsive force (load) of the impact energy absorbing component observed when the plate thickness of the low-rigidity ductile fracture portion alone is increased and the repulsive energy at unit deformation is enhanced, as in comparative example 2; and

FIG. 10 is a graph depicting the relationship between deformation volume and repulsive force (load) observed when collision performance is evaluated for the high-rigidity brittle fracture portion alone, as in comparative example 3.

### DESCRIPTION OF THE PREFERRED EMBODIMENTS

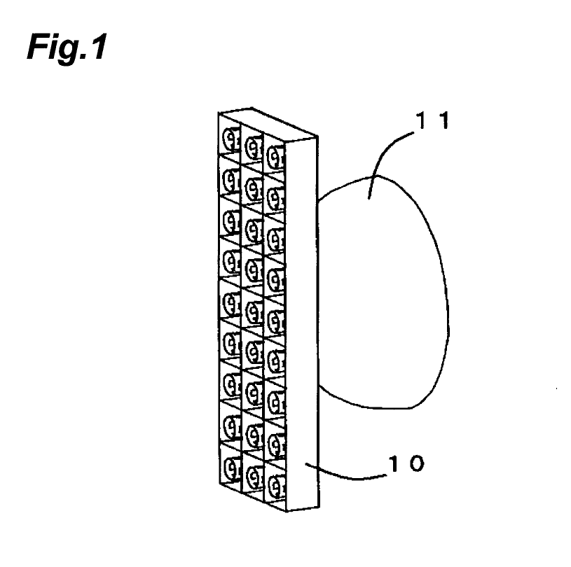

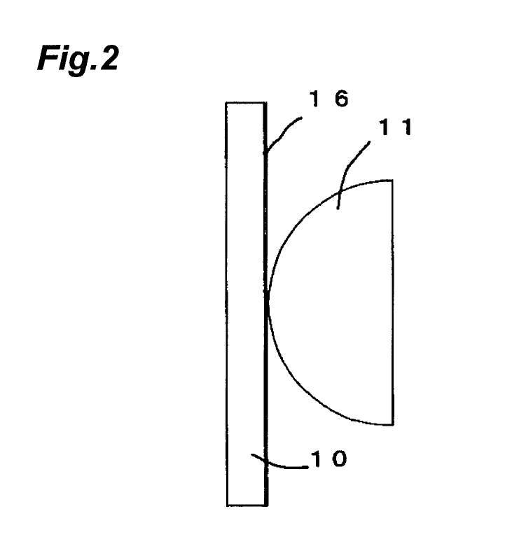

The present invention is described in detail below with reference to the diagrams. FIGS. 1 and 2 are schematic views of an impact energy absorbing component 10 of the present invention and a colliding object 11 for performance evaluation. FIG. 1 is a perspective view seen from the structure's side of an automobile, and FIG. 2 is a side view. Thicknesses are omitted in these diagrams. In this embodiment, the impact energy absorbing component 10 is composed of a high-rigidity brittle fracture portion 12 and a low-rigidity ductile fracture portion 13, which are formed separately.

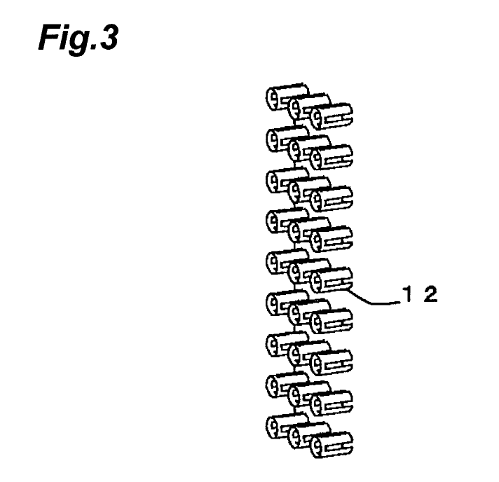

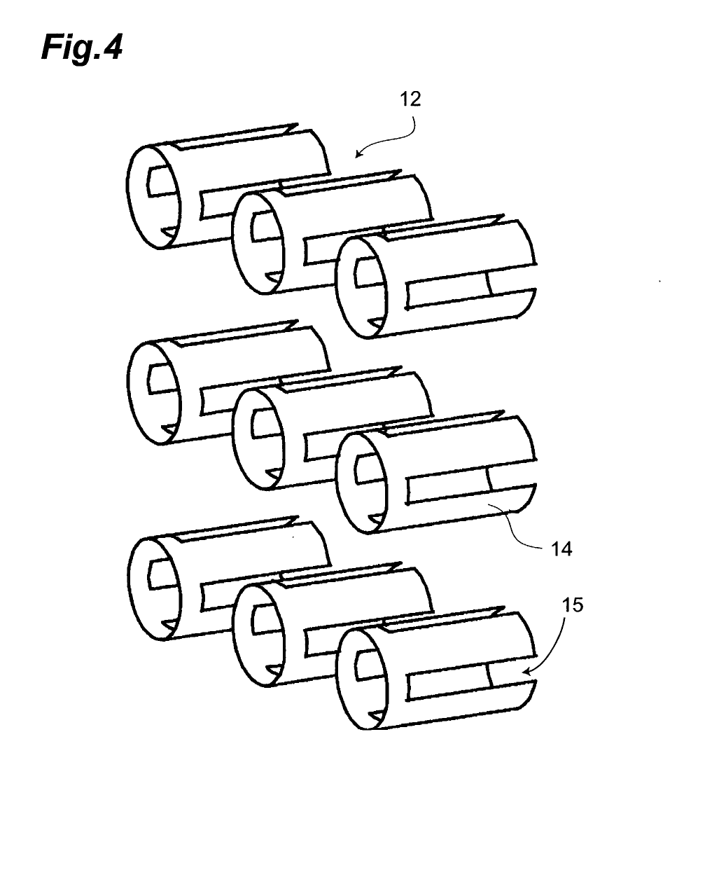

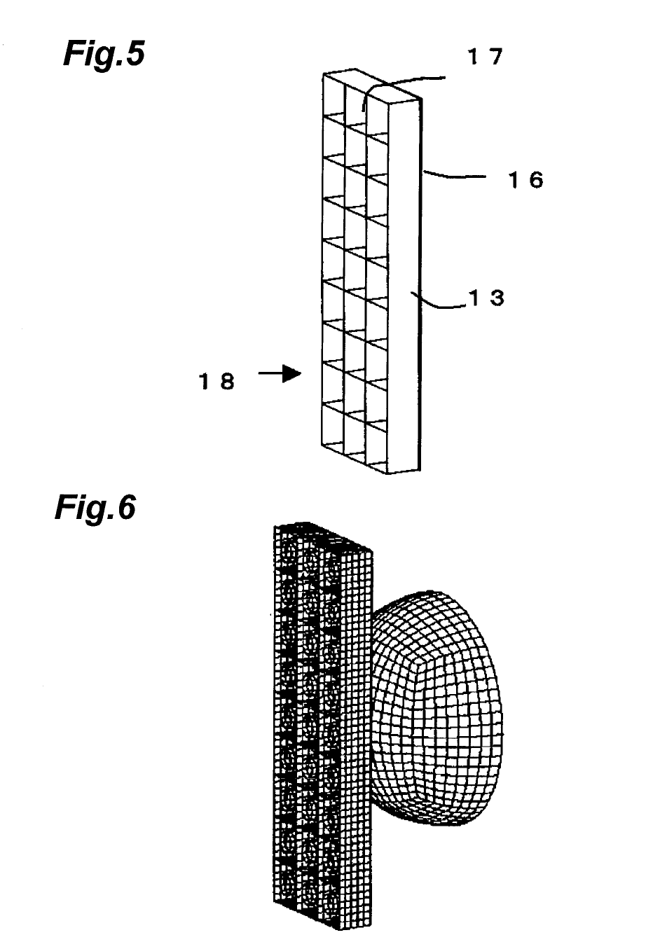

FIG. 3 is a schematic view depicting the high-rigidity brittle fracture portion 12, and more specifically a component that has a large repulsive force at unit deformation and undergoes fracture at a small deformation volume; and FIG. 4 is an expanded view thereof. FIG. 5 is schematic view depicting the low-rigidity ductile fracture portion 13, and more specifically a component that has a small repulsive force at unit deformation and undergoes fracture at a large deformation volume.

In the present embodiment, the high-rigidity brittle fracture portion 12 comprises a plurality of cylindrical members 14. Formed in the cylindrical members 14 are notches (fragile sections) 15 extending along the direction of impact and opening in the front end. The notches 15 may be designed to taper out towards the front end of the cylindrical members 14.

The low-rigidity ductile fracture portion 13 constitutes a rib-structured body 18, which is formed by integrating a front plate 16 facing toward the collision direction and a lattice-shaped rib plate 17 extending along the collision direction. The cylindrical members 14 are disposed in the lattices of the rib-structured body 18. The cylindrical members 14 and rib-structured body 18 may be provided so as to restrain each other, as long as they can be deformed substantially independently. In this example, the rear edge of the rib plate 17 and the rear edge of the cylindrical members 14 are substantially coplanar, and the two begin to deform simultaneously during a collision. It is also possible, however, to dispense with the coplanar arrangement and to allow one of the components to start deforming with a delay.

In the present embodiment, the high-rigidity brittle fracture portion 12 and the low-rigidity ductile fracture portion 13 are formed separately using different materials; more specifically, the high-rigidity brittle fracture portion 12 is formed with high-rigidity material and the low-rigidity ductile fracture portion 13 is formed with low-rigidity material to make it easier to design the way in which individual roles are distributed in the deformation process. However, the embodiments of the present invention are not limited thereto. For example, the components may be formed separately using the same material, which poses no problems since rigidity can be set by the thickness and shape of the material. The components can be integrally formed from different materials by employing a special method, eliminating the labor needed to combine the two together. Of course, they can also be integrally formed using the same material. When the two are molded in an integrated manner, it is preferable to form the high-rigidity brittle fracture portion 12 and low-rigidity ductile fracture portion 13 such that they are clearly distinguishable, and to join them such that they do not affect each other during the formation process.

In any case, structurally forming the fragile sections 15 in the high-rigidity brittle fracture portion 12 makes it possible to set the brittle fracture strength of the material irrespective of its strength. In the above-mentioned embodiment, the notches 15 are formed in the cylindrical members 14, and high repulsive force is exhibited during the initial stages of deformation, but the cylindrical members 14 expand from the front edge and undergo fracture due to the notch effect of the notches 15 as deformation progresses, making it possible to achieve fracture at relatively small deformation.

For the high-rigidity brittle fracture portion 12 in the present embodiment, the limiting deformation to fracture should be less than half the length D₁ [mm] in the direction of deformation, and the rigidity K₁ [kN/m] should meet the conditions indicated by Eq. (1). E [J] indicates the kinetic energy of the colliding object.

K₁≧8E/D₁² (1)

For the low-rigidity ductile fracture portion 13 in the present embodiment, the limiting deformation to fracture should be equal to or greater than the length D₂ [mm] in the direction of deformation, and the rigidity K₂ [kN/m] should meet the conditions indicated by Eq. (2).

K₂<8E/D₂² (2)

The present invention is described in further detail below with reference to examples, but the present invention is not limited to these examples.

The impact energy absorbing component 10 (which is an embodiment of the present invention) is configured as described above, and the high-rigidity brittle fracture portion 12 is a cylinder with a diameter of 15 mm, a height of 26 mm, and a thickness of 1.2 mm. Provided thereto are four notches 3.9 mm in width and 21 mm in length. The low-rigidity ductile fracture portion 13 is a lattice-shaped rib structure 20 with a length of 270 mm, a width of 90 mm, a height of 26 mm, a plate thickness of 0.6 mm, and a pitch of 30 mm. The high-rigidity brittle fracture portion 12 is disposed in parallel so as to fit into each lattice of the low-rigidity ductile fracture portion 13.

The performance of the impact energy absorbing component 10 is evaluated by a method such as the one shown in FIG. 1. Specifically, the front side of the impact energy absorbing component is placed facing a barrier (a fixed wall), a hemispherical colliding object 11 with a mass of 6.8 kg and a diameter of 165 mm is made to collide from the rear side at 5.0 m/s, and the deformation volume and repulsive force (load) of the impact energy absorbing component are measured. The performance the impact energy absorbing component 10 is evaluated by a simulation using a computer. Analytical techniques are already well-known, and software for this task is commercially available. FIG. 6 depicts a geometrical model in this type of analysis.

(User Software)

LS-DYNA version 940 (made by Livermore Software Technology Corporation)

(Analytical Techniques)

Spatial Discretization: Finite Element Method

Temporal Integration: Explicit Method based on Central Differences

(Fixation Conditions for Impact Energy Absorbing Component)

Defining a Rigid Wall Opposite a Colliding Object

The following values, such as modulus of elasticity and rupture stress, were used for the material in the high-rigidity brittle fracture portion 12 of the impact energy absorbing component of the present invention.

Modulus of Elasticity: 10400 MPa

Rupture Stress: 356 MPa

Poisson's Ratio: 0.35

Specific Gravity: 1.22

Material Model: LS-DYNA Physical Properties Type 19

The following values, such as modulus of elasticity and rupture stress, were used for the material in the low-rigidity ductile fracture portion 13 of the impact energy absorbing component of the present invention.

Modulus of Elasticity: 863 MPa

Yield Stress: 19.6 MPa

Ruptured Composition Distortion: 0.40

Poisson's Ratio: 0.40

Specific Gravity: 0.90

Material Model: LS-DYNA Physical Properties Type 24

Parameters of Cowper-Symonds equation: C=2.80s−1, P=9.87

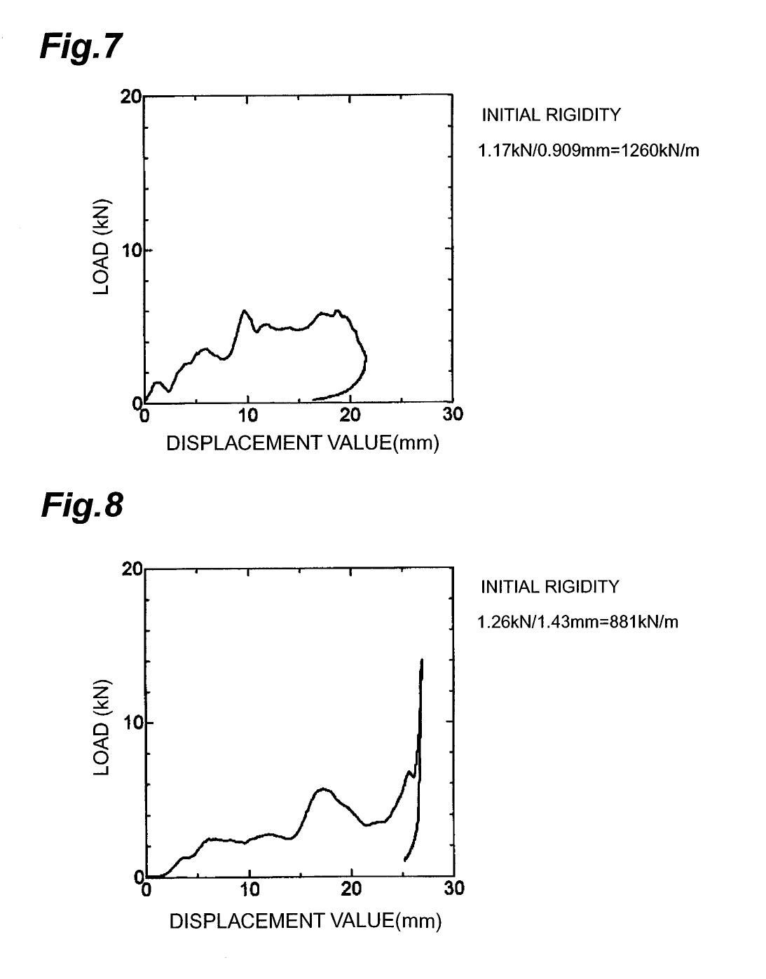

FIG. 7 depicts the relationship between deformation volume [mm] and repulsive force (load) [kN] observed when the collision performance of the inventive impact energy absorbing component is evaluated by simulation. It can be seen that deformation stops at 21 mm, the maximum value of repulsive force reaches 6 kN, and adequate impact absorbing abilities can be ensured with small deformation.

### COMPARATIVE EXAMPLE 1

FIG. 8 depicts the relationship between deformation volume [mm] and repulsive force (load) [kN] observed when a simulation is used to evaluate collision performance with the low-rigidity ductile fracture portion 13 alone, as in the above example. It can be seen by the diagram that when the deformation volume reaches 26 mm, a collision body for performance evaluation collides with the structural members of the automobile and the repulsive force rapidly increases, exhibiting insufficient impact energy absorbing abilities.

### COMPARATIVE EXAMPLE 2

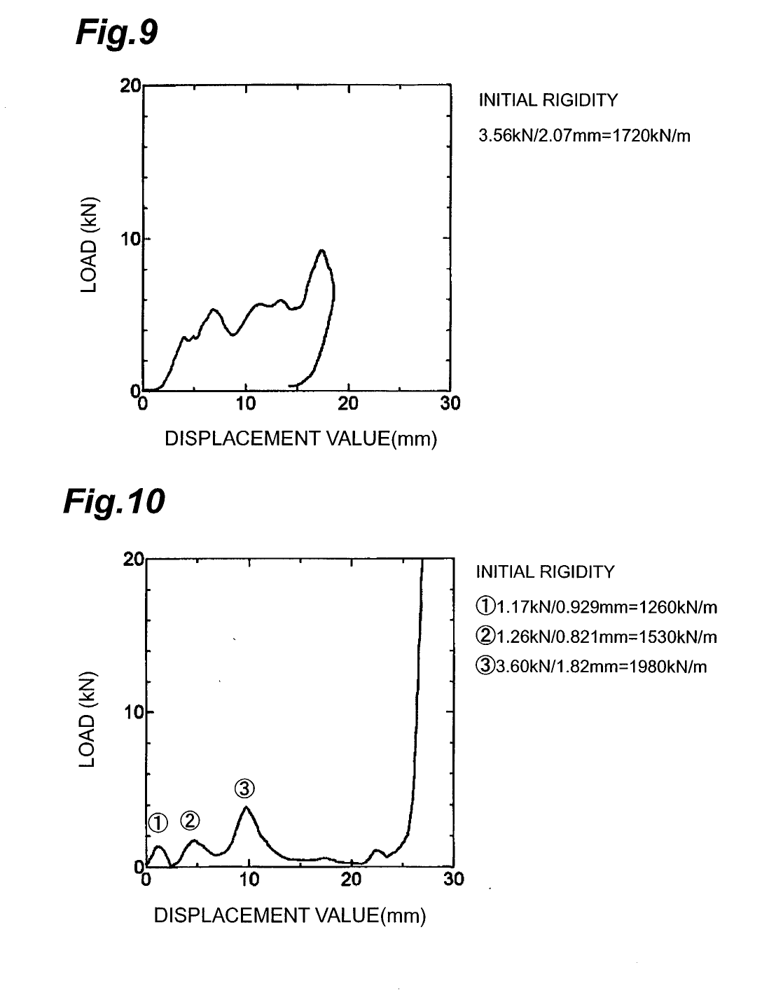

FIG. 9 depicts the relationship between deformation volume [mm] and repulsive force (load) [kN] observed when a simulation is used to evaluate collision performance of a lattice-shaped rib structure with a length of 270 mm, a width of 90 mm, a height of 26 mm, a thickness of 1.0 mm, and a pitch of 30 mm (rigidity is increased by setting the plate thickness at 1.0 mm). Deformation is stopped at 18 mm. The maximum value of repulsive force up until 15 mm is substantially identical to that of the above example at 6 kN, but the maximum value increases to 9 kN at a deformation volume of 15 mm or greater, and it can be seen that the impact energy absorbing abilities are inferior to those of the above example.

### COMPARATIVE EXAMPLE 3

FIG. 10 is a graph depicting the relationship between deformation volume [mm] and repulsive force (load) [kN] observed when collision performance is evaluated for the high-rigidity brittle fracture portion 12 alone, as in the above example. When the deformation volume reaches 10 mm, the high-rigidity brittle fracture portion 12 fractures and the repulsive force rapidly decreases. Furthermore, when the deformation volume subsequently reaches 26 mm, a collision body for performance evaluation collides with the automobile structure, and the repulsive force rapidly increases.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A resin impact energy absorbing component, disposed between a structural member of an automobile and a resin internal material arranged on the inner side of the compartment with respect to the structural member, wherein the impact energy absorbing component is constituted by arranging parallel to each other a high-rigidity brittle fracture portion and a low-rigidity ductile fracture portion.

2. The impact energy absorbing component according to claim 1, wherein the high-rigidity brittle fracture portion fractures before the low-rigidity ductile fracture portion does during the deformation of the impact energy absorbing component and ceases to be involved in impact energy absorption.

3. The impact energy absorbing component according to claim 1, wherein a structurally fragile section is formed in the high-rigidity brittle fracture portion.

4. A resin impact energy absorbing component, disposed between a structural member of an automobile and a resin internal material arranged on the inner side of the compartment with respect to the structural member, wherein the impact energy absorbing component is constituted by arranging parallel to each other a high-rigidity brittle fracture portion and a low-rigidity ductile fracture portion that has a lower load versus deformation and a higher limiting deformation to fracture than does the high-rigidity brittle fracture portion.

5. The impact energy absorbing component according to claim 4, wherein a planar base is provided;
the high-rigidity brittle fracture portion is constituted by arranging a plurality of notched cylinder members in a matrix on a surface of the base; and
the low-rigidity ductile fracture portion is constituted by arranging plate-shaped members in a lattice so as to be perpendicular to the surface of the base.
